(19) United States
(12) Patent Application Publication
(10) Pub. No.: US 2005/0205534 A1
(43) Pub. Date: Sep. 22, 2005

(54) Single and dual lensed optical waveguide for uniform welding

(76) Inventor: Scott Caldwell, Fairport, NY (US)

Correspondence Address: HARNESS, DICKEY & PIERCE, P.L.C., P.O. BOX 828, BLOOMFIELD HILLS, MI, 48303, US

(21) Appl. No.: 11/083,079

(22) Filed: Mar. 17, 2005

Related U.S. Application Data
(60) Provisional application No. 60/554,162, filed on Mar. 18, 2004.

(51) Int. Cl. B23K 26/24; B23K 26/06

(52) U.S. Cl. 219/121.63; 219/121.8; 219/121.73

(57) ABSTRACT

A single and dual lensed optical waveguide capable of approximating a desired IQP light profile to produce uniform welding with two overlapping Gaussian light profiles that are mirror folded back on themselves. This allows for a resolution of the laser light that comes out of a fiber bundle in a weld width of under 1/100,000th of an inch. The results are narrow, uniform plastics TTIr welds that show no signs of bubbling.

### CROSS-REFERENCE TO RELATED APPLICATIONS

This application claims the benefit of U.S. Provisional Application No. 60/554,162, filed on Mar. 18, 2004, the disclosure of which is incorporated herein by reference.

### FIELD OF THE INVENTION

The present invention relates generally to laser welding and, more particularly, relates to single and dual lensed optical waveguide for improved welding performance.

### BACKGROUND OF THE INVENTION

Laser welding is commonly used to join plastic or resinous parts, such as thermoplastic parts, at a welding zone. An example of such use of lasers can be found in U.S. Pat. No. 4,636,609, which is expressly incorporated herein by reference.

As is well known, lasers provide a semi-focused beam of electromagnetic radiation at a specified frequency (i.e., coherent monochromatic radiation). There are a number of types of lasers available; however, infrared lasers or non-coherent sources provide a relatively economical source of radiative energy for use in heating a welding zone. One particular example of infrared welding is known as Through-Transmission Infrared (TTIr) Welding. TTIr welding employs an infrared laser capable of producing infrared radiation that is directed by lenses, diffractive optics, fiber optics, waveguides, lightpipes or lightguides through a first plastic part and into a second plastic part. This first plastic part is often referred to as the transmissive piece, since it generally permits the laser beam from the laser to pass therethrough. However, the second plastic part is often referred to as absorptive piece, since this piece generally absorbs the radiative energy of the laser beam to produce heat in the welding zone. This heat in the welding zone causes the transmissive piece and the absorptive piece to be melted and, with intimate contact, welded together.

Radiative energy produced by the infrared laser can be delivered to the targeted weld zone through a number of transmission devices—such as a single optical fiber, a fiber optic bundle, a waveguide, a light guide, or the like—or simply by directing a laser beam at the targeted weld zone. In the case of a fiber optic bundle, the bundle may be arranged to produce either a single point source laser beam, often used for spot welding, or a generally linearly distributed laser beam, often used for a linear weld. Each of these arrangements and transmission devices suffer from a number of disadvantages inherent in their designs.

By way of example, a single optical fiber typically produces an output beam having a generally-Gaussian laser intensity—the center of the targeted weld zone receives an increased concentration of radiative energy relative to the outer edges of the weld zone. This increased concentration of radiative energy near the center of the weld zone often causes the center of the weld zone to become overheated, resulting in disadvantageous “bubbling” and/or out-gassing in the center area of the weld zone.

However, this overheating and the resultant “bubbling” and/or outgassing in the center area of the weld zone is not overcome simply by using a fiber optic bundle. Although it is known that a fiber optic bundle causes the generally-Gaussian or parabolic laser intensity output from a single optic fiber to be substantially normalized to produce an overall, generally uniform, laser intensity output, the center area of the weld zone is still often overheated. In the art, this overall, generally uniform, laser intensity output from a fiber optic bundle is known as a “top hat” distribution, which is a relatively accurate representation in near-field applications.

However, what is not readily appreciated in the art today is that although a generally-uniform laser intensity output can be achieved using a fiber optic bundle, such uniform intensity beams do not necessarily reduce the overheating, “bubbling”, and/or out-gassing in the center area of the weld zone. Due to heat transfer principles, even with a uniform intensity beam, heat will build up faster in the center of the weld zone than along the edges of the weld zone.

One solution to overcome the disadvantages in the prior art is disclosed in commonly-owned U.S. patent application Ser. No. 10/323,151, which is incorporated herein by reference. This solution is particularly useful in applications requiring a weld approximately greater than 1/100,000th of an inch wide. However, in applications requiring a narrow weld, a need in the relevant art continues. Specifically, the solution disclosed in the '151 application is unable to resolve the necessary Inverted Quasi Parabolic (IQP) light profile for a weld that narrow.

Accordingly, there exists a need in the relevant art to provide an apparatus capable of producing an evenly distributed temperature profile throughout a narrow target zone in order to produce a consistent weld joint that is generally less than 1/100,000th of an inch wide. Additionally, there exists a need in the relevant art to provide an apparatus and method of using the same that is capable of overcoming the disadvantages of the prior art.

### SUMMARY OF THE INVENTION

The Single and Dual Lensed Optical Waveguide of the present invention overcomes the difficulties in the prior art by approximating the needed IQP light profile shown to produce uniform welding with two overlapping Gaussian light profiles that are mirror folded back on themselves. This allows for a resolution of the laser light that comes out of a fiber bundle in a weld width of under 1/100,000th of an inch. The results are narrow, uniform plastics TTIr welds that show no signs of bubbling.

Because of defocusing of the laser beam out of the fiber optic ferrules used to deliver the laser light, in narrow welds (under 1/100,000th of an inch wide) normal tailored lenses or mirror surfaces cannot achieve the IQP profile. The present invention details how to achieve an approximation to the IQP profile by using two overlapping half Gaussian light profiles created by various lens and waveguide combinations. This approximation to the IQP profile produces uniform plastics TTIr welds with no signs of bubbling.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a near field and far field laser intensity of a fiber optic ferrule;

FIG. 2 illustrates individual divergent Gaussian laser intensities coming out of individual optical fibers;

FIG. 3 illustrates IQP light intensity profile needed for uniform welding compared to a dual half Gaussian approximation;

FIG. 4 illustrates an individual Gaussians focused to one point and then halved in a mirror plane;

FIG. 5 illustrates a waveguide that produces an approximation to the IQP light profile using two half Gaussians;

FIG. 6 illustrates geometry of an individual divergent Gaussian coming out of an individual optical fiber;

FIG. 7 illustrates a scalloped waveguide that corrects for even welding in the longitudinal direction;

FIG. 8 illustrates a scalloped lens-waveguide that corrects for even welding in both the lateral and the longitudinal directions;

FIG. 9 illustrates a positive linear lens-waveguide system that corrects for even welding in both the lateral and longitudinal directions; and

FIG. 10 illustrates a negative linear lens-waveguide system that corrects for even welding in both the lateral and longitudinal directions.

### DETAILED DESCRIPTION OF THE PREFERRED EMBODIMENT

The following description of the preferred embodiment is merely exemplary in nature and is in no way intended to limit the invention, its application, or uses.

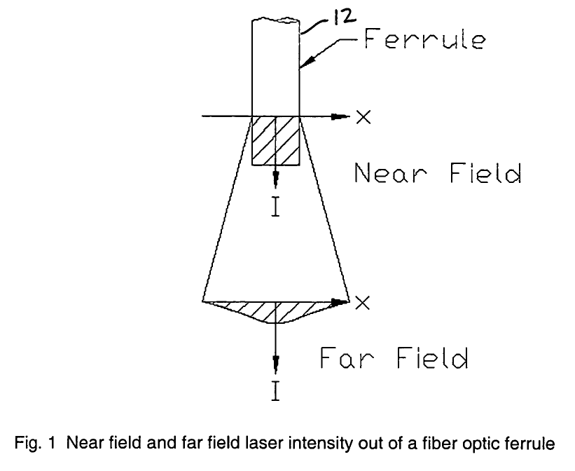

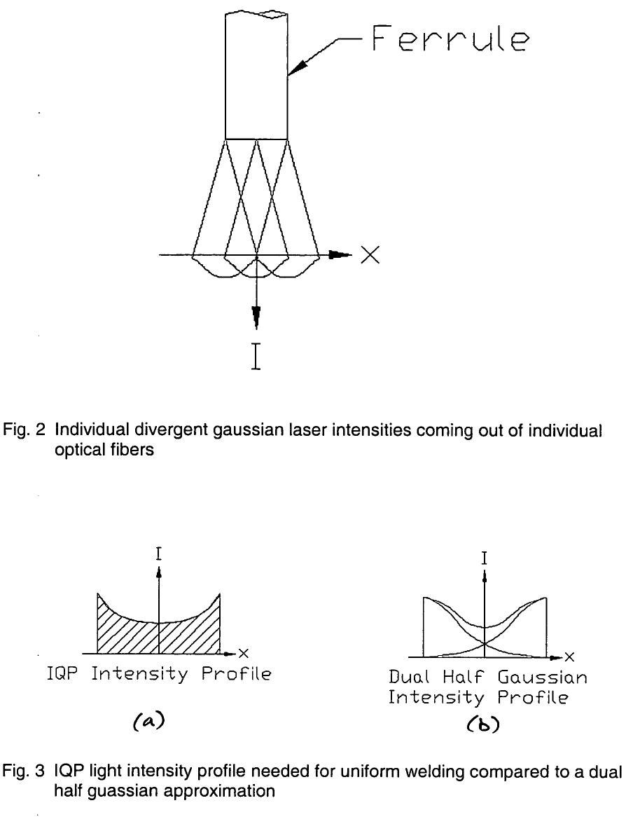

As best seen in FIG. 1, the intensity output of an optical fiber ferrule 12 is a diverging Gaussian profile in the far field and a “top hat” in the near field. This indicates that each individual fiber in the ferrule bundle is a diverging Gaussian as seen in FIG. 2. This is a problem for designing beam tailoring lenses using the parallel ray approximation because the actual beam defocuses the results too much. Attempts to use a curved mirror surface or a tailored lens surface are thwarted by the overall defocusing effect.

This defocusing effect can be overcome by using the Gaussian profile of each point source combined. As described in the aforementioned commonly-owned U.S. patent application Ser. No. 10/323,151, the desired light intensity profile to produce a uniform weld is an Inverted Quasi-Parabolic (IQP), as illustrated in FIG. 3a. This IQP profile can be approximated by two overlapping half Gaussians, also seen in FIG. 3b.

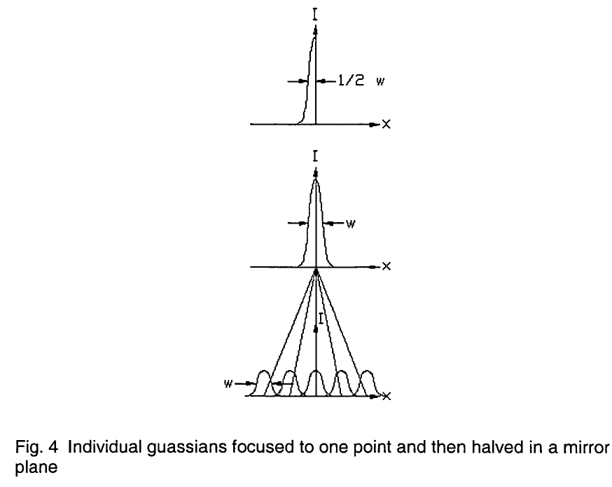

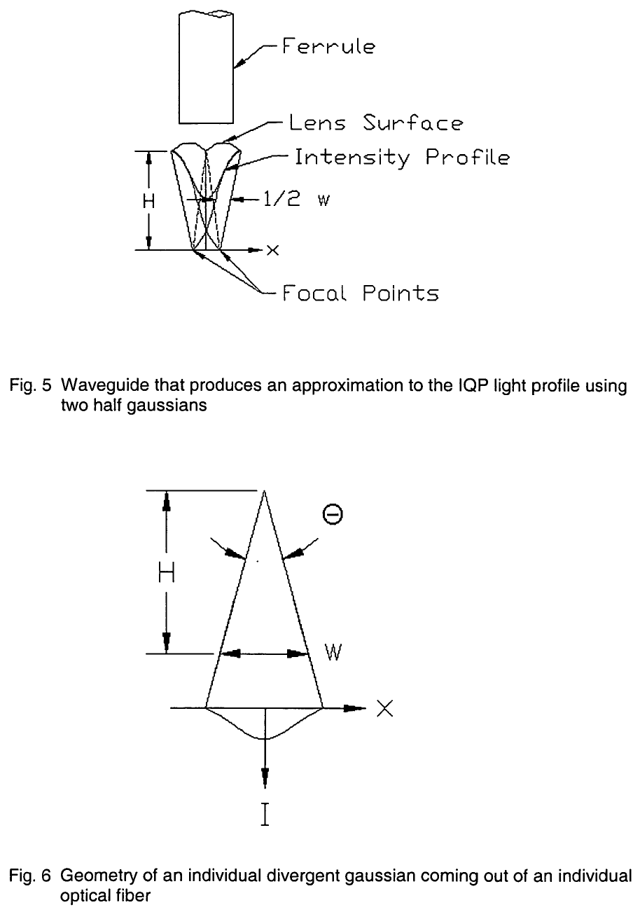

As seen in FIG. 4, if all the individual Gaussians of each fiber are focused on one spot, the result is a Gaussian with the same width as the individual Gaussians, but with a higher amplitude. Mirroring the resultant Gaussian about its axis produces a half Gaussian with twice the amplitude. If half the fibers are focused to one side wall of a waveguide, and the other half are focused to the other side wall, two half Gaussians are created as seen in FIG. 5.

The height H of the waveguide is based on the width of the bottom of the waveguide and the angle 0 of the dispersion of the Gaussian coming out of the fiber such that:

$$H = \frac{w}{tan ( θ )}$$

where ½ w is the desired half width of the Gaussian as seen in FIG. 6.

The height of the waveguide, when calculated to produce the best approximation to the IQP profile in the lateral direction along a weld, is shorter than the ideal height of an ideal waveguide needed for uniform mixing of the light between ferrules in the longitudinal direction.

Two solutions present themselves to allow for a uniform mixing in the longitudinal direction.

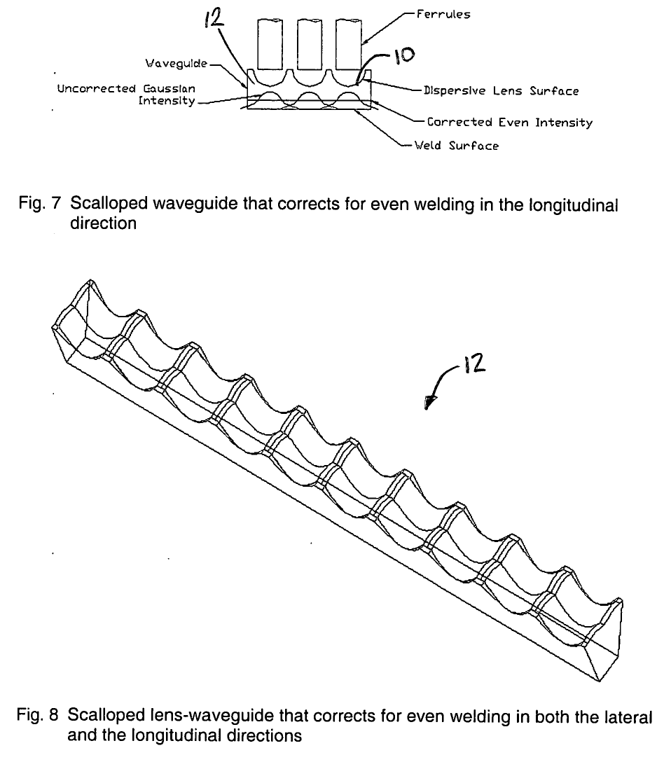

The first solution is to use a dispersive lens surface 10 in the top of the waveguide 12 that corrects the uneven Gaussian intensity in the longitudinal direction into an even intensity as seen in FIG. 7. The resultant combined scalloped lens-waveguide 12 is seen in FIG. 8.

An alternate solution is to move the focal plane down the waveguide in the lateral direction only, preserving the small Gaussian spread necessary to produce the approximation to the IQP profile, but allowing for mixing of the light between ferrules in the longitudinal direction as provided by a taller waveguide. From the new focal plane, a non-scalloped, linear tailored lens-waveguide produces the desired approximation to the IQP profile.

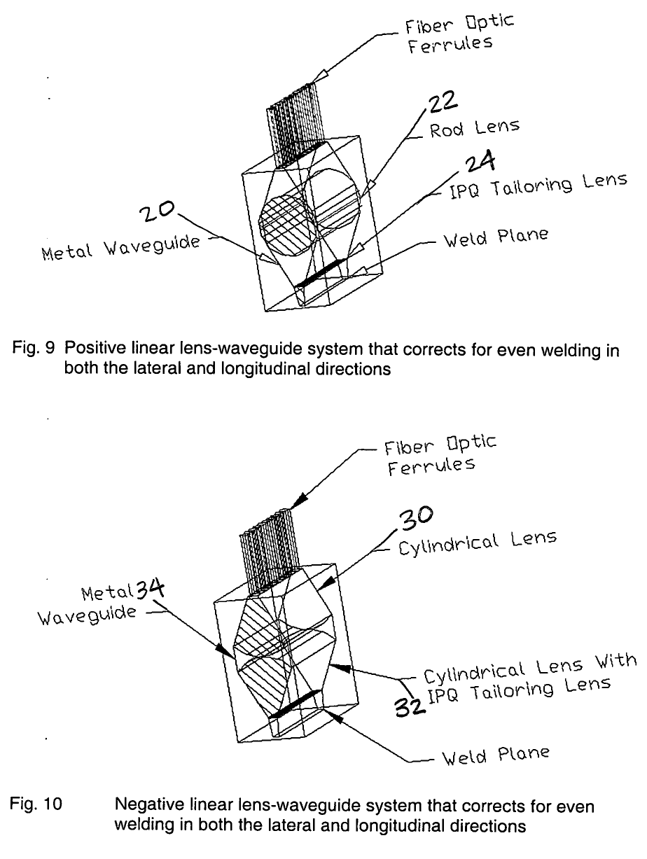

There are two possible versions of this dual-lensed scheme as seen in FIGS. 9 and 10. One version uses positive lensing, and the other uses negative lensing, but the optical results are the same. The advantage of the dual-lensed scheme over the single-lensed, scalloped scheme is that the linear lenses used in the dual-lensed scheme are easier to manufacture than the complex shapes in the scalloped scheme.

There are three basic embodiments of lens and waveguide combinations needed to create the approximation to the IQP light profile for narrow welds.

The first one, as seen in FIG. 8, is scalloped along its top in the longitudinal direction and has dual convergent lens surfaces in the lateral direction. The waveguide portion 12 is tapered down to the width of the weld line to be created. This lens-waveguide can be made of any clear (to infrared) dielectric material, but for ease of manufacture, is preferably made with steriolith techniques or microchip fabrication techniques due to its small features.

The second embodiment as seen FIG. 9 uses two lens elements housed in a metal waveguide 12. First the light is focused in the lateral direction by a rod lens 22 down to the top of a dual convergent lens 24. The lower part of the waveguide 20 forms the approximate IQP light profile in the lateral direction while allowing for full light mixing in the longitudinal direction. The lens portions 22, 24 of this lens-waveguide combination can be made of any clear (to infrared) dielectric material. The preference is to make them out of clear silicone because silicone is less susceptible to heat and possible burning. The waveguide 20 can be made of any reflective material, but the preference is to make it out of gold plated metal for durability and high reflectivity in the infrared.

The third embodiment is seen in FIG. 10. This is a negative lens version of the lens-waveguide used in FIG. 9. Two cylindrical lens surfaces 30, 32 direct the focal plane of the light to just above a dual convergent lens. Once again the lower part of the waveguide 34 forms the approximate IQP light profile in the lateral direction while allowing for full light mixing in the longitudinal direction. The lenses 30, 32 and waveguide 34 are made of the same materials as the version in FIG. 9.

The figures show only linear arrangements of the lens-waveguides, but any curve or intersection can also be accommodated by any of the lens-waveguide combinations. Also the weld plane is shown to be flat, but any curvilineature surface can be accommodated for.

Currently TTIr plastics welds can be made bubble free by using an IQP light intensity profile using tailored lenses or mirrors for welds as thin as 1/100,000th of an inch wide. The invention of the use of the dual half Gaussian approximation of the IQP light intensity profile allows for bubble free TTIr plastics plunge welds to be made that are narrower than 1/100,000th of an inch.

The scalloped version of the lens-waveguide as seen in FIG. 8 is difficult to manufacture because of its compound lens surfaces and small feature sizes. The linear versions in FIGS. 9 and 10 are easier to manufacture because the lens shapes are not compound. The feature sizes in the linear versions are still small however, and if the waveguides are used in complex curves and intersections, it currently requires a steriolith master to make the lens parts. Additionally, because of the width of the rod lenses or cylindrical lenses, it is difficult to put two weld lines in close proximity to each other.

The description of the invention is merely exemplary in nature and, thus, variations that do not depart from the gist of the invention are intended to be within the scope of the invention. Such variations are not to be regarded as a departure from the spirit and scope of the invention.

1. A laser welding lens assembly for welding a first article to a second article at a weld zone, said laser welding lens assembly comprising:
a laser source outputting a laser beam;
an optical fiber being operably coupled to said laser source for receiving and transmitting said laser beam; and
a lens system being positioned to receive said laser beam from said optical fiber, said lens system focusing said laser beam to produce an overlapping Gaussian laser beam profile.
